(19) United States
(12) Patent Application Publication
(10) Pub. No.: US 2019/0145810 A1
(43) Pub. Date: May 16, 2019

(54) DEVICE COMPRISING A CANNED MOTOR FOR MEASURING FLOW PROCESSES OF MEASURING FLUIDS

(71) Applicant: AVL LIST GMBH, GRAZ (AT)

(72) Inventors: HERIBERT KAMMERSTETTER, SALZBURG (AT); OTFRIED DERSCHMIDT, GRAZ (AT)

(73) Assignee: AVL LIST GMBH, GRAZ (AT)

(21) Appl. No.: 15/759,524

(22) PCT Filed: Sep. 15, 2016
(86) PCT No.: PCT/EP2016/071758

§ 371 Date: Mar. 13, 2018

(30) Foreign Application Priority Data
Sep. 15, 2015 (AT) A600-2015

(51) Int. Cl. G01F 3/10

(52) U.S. Cl. CPC G01F 3/10; F04C 2/10

(57) ABSTRACT

A device for measuring flow processes of a measuring fluid. The device includes an inlet, an outlet, a positive displacement housing, a drive unit, a positive displacement flow meter driven by the drive unit arranged in the positive displacement housing, a bypass which bypasses the positive displacement flow meter, a differential pressure sensor arranged in the bypass; and an evaluation and control unit which controls the positive displacement flow meter based on a pressure difference existing at the differential pressure sensor. The drive unit includes a canned motor which includes a drive shaft, a rotor, and a stator with windings, and a can which separates an inner chamber, which is filled with the measuring fluid and which holds the drive shaft and the rotor, from an outer chamber, which holds the stator.

### CROSS REFERENCE TO PRIOR APPLICATIONS

This application is a U.S. National Phase application under 35 U.S.C. § 371 of International Application No. PCT/EP2016/071758, filed on Sep. 15, 2016 and which claims benefit to Austrian Patent Application No. A 600/2015, filed on Sep. 15, 2015. The International Application was published in German on Mar. 23, 2017 as WO 2017/046199 A1 under PCT Article 21(2).

### FIELD

The present invention relates to a device for measuring the flow processes of measuring fluids, comprising an inlet, an outlet, a positive displacement flow meter which can be driven by a drive unit and which is situated in a positive displacement housing, a bypass that allows the positive displacement flow meter to be bypassed, a differential pressure sensor which is situated in the bypass, and an evaluation and control unit that allows the drivable positive displacement flow meter to be controlled in accordance with the differential pressure applied to the differential pressure sensor.

### BACKGROUND

Such devices have been known for several years and are used, for example, to inject a quantity measurement in internal combustion motors.

The original version of such a device for through-flow measurement was described in DE-AS 1 798 080. This electronically controlled flow meter comprises a main conduit with an inlet and an outlet, in which a rotary positive displacement flow meter in the form of a gear pump is arranged. A bypass runs parallel to the main conduit, via which bypass the rotary positive displacement flow meter can be bypassed and in which a piston serving as a differential pressure sensor is arranged in a measuring chamber. The excursion of the piston in the measuring chamber is measured using an optical sensor to determine the flow rate. The rotational speed of the gear pump is constantly readjusted via an evaluation and control unit based on this signal, the readjustment being such that the piston is always returned to its initial position, if possible, so that only small flows are generated in the bypass. The flow rate within a predefined time interval is calculated in this manner from the number of rotations or partial rotations of the gear pump measured by an encoder and from the known delivery quantity of the gear pump per revolution.

A flow quantity measuring device of this structure is also described in DE 103 31 228 B3. For determining the exact injection quantity profiles, the gear pump is set to a constant rotational speed prior to the start of each injection, so that the movement of the piston is measured subsequently, with this excursion being used to determine the injection profiles. A pressure sensor and a temperature sensor are also arranged in the measuring chamber, the measuring values of which are also supplied to the computing unit to calculate and correct the injection quantity profiles.

These measuring devices require that a variable drive unit be used in which both the control and the position detection can be performed at a high speed for a correct conversion of the conveyed measuring fluid. Care should thereby be taken that the measuring fluid causes no damage to the drive unit even if a corrosive measuring fluid is used.

Electric motors are therefore typically used to drive these positive displacement flow meters, wherein the output shaft of the motor has an external rotor of a magnetic clutch fastened thereon, the external rotor carrying permanent magnets, while the internal rotor of the clutch is separated from the external rotor by a can. Such a magnetic clutch is described, for example, in WO 2015/018568 A1.

It has been found, however, that measuring errors may occur due to the elasticity of the magnetic clutch as well as to the fact that a full entrainment of the external rotor to the internal rotor of the magnetic clutch cannot be guaranteed. Measuring inaccuracies are also caused by air inclusions in the can which are released during operation and enter into the conveying chamber of the positive displacement flow meter.

### SUMMARY

An aspect of the present invention is to provide a device for measuring flow processes of measuring fluids with which measuring results are improved by optimizing the drive. Costs should thereby be reduced and only a small structural space used. The control of the drive unit should be performed as precisely as possible independent of the required feed volumes. A position feedback of the impeller should be as precise as possible, wherein errors caused by occurring elasticities should be excluded.

In an embodiment, the present invention provides a device for measuring flow processes of a measuring fluid. The device includes an inlet, an outlet, a positive displacement housing, a drive unit, a positive displacement flow meter configured to be driven by the drive unit arranged in the positive displacement housing, a bypass configured to bypass the positive displacement flow meter, a differential pressure sensor arranged in the bypass, and an evaluation and control unit configured to provide a control of the positive displacement flow meter based on a pressure difference existing at the differential pressure sensor. The drive unit comprises a canned motor comprising a drive shaft, a rotor, and a stator comprising windings, and a can configured to separate an inner chamber, which is filled with the measuring fluid and which holds the drive shaft and the rotor, from an outer chamber, which holds the stator.

### BRIEF DESCRIPTION OF THE DRAWINGS

The present invention is described in greater detail below on the basis of embodiments and of the drawings in which:

FIG. 1 shows a schematic illustration in the form of a flow diagram of a device for measuring flow processes of fluids according to the present invention;

FIG. 2 shows a perspective view on the outer side of the device of the present invention;

FIG. 3 shows a perspective view on a drive unit adapted for connection to a displacer housing; and

FIG. 4 shows a sectional view on the drive unit mounted to the displacer housing.

### DETAILED DESCRIPTION

Because the drive unit is formed by a canned motor, where a can separates an inner chamber filled with measuring fluid, in which a drive shaft and a rotor of the canned motor are arranged, from an outer chamber in which a stator of the canned motor is arranged, the stator being provided with windings, it is achieved that the electric motor directly drives the positive displacement flow meter so that no intermediate components are required which result in costs and which increase the elasticity between the electric motor and the impeller. The required structural space is also reduced. A canned motor is a DC motor that is usually electronically commutated.

In an embodiment of the present invention, an impeller of the positive displacement flow meter can, for example, be fastened on the drive shaft of the canned motor at least so that it rotates therewith and with the rotor of the canned motor, which is provided with permanent magnets, which can, for example, be fastened on the drive shaft of the canned motor at least so that is rotates therewith or is manufactured integrally with the drive shaft so that the impeller is driven directly. An elasticity of an intermediate clutch is thereby omitted. A position feedback on the position of the impeller can instead be provided directly via the driven shaft. A very exact control and calculation of the conveyed volume flow thereby becomes possible.

In an embodiment of the present invention, a first bearing seat and a second bearing seat are formed at axial ends of the can, respectively, in which a first bearing and a second bearing are arranged which support the drive shaft. Additional bearings for supporting the impeller are not required since the spaced arrangement of the bearings allows for a reliable absorption of the transversal forces occurring.

To achieve a particularly simple assembly of the electric motor to the displacer housing, the can has a flange via which the canned motor is fastened to the displacer housing of the positive displacement flow meter. A reliable sealing of the can inner chamber to the outer chamber is thus also provided.

In an embodiment of the present invention, a collar of the can, in which the first bearing is arranged, extends from the flange into an opening of the displacer housing. It is thereby possible to pre-fix the can on the displacer housing simply by plugging. The distance between the front bearing and the impeller is also minimized, whereby transversal forces occurring can again be absorbed directly.

In an embodiment of the present invention, the can can, for example, have a closed bottom at the axial end far from the displacer housing. The can is therefore only open to the displacer housing. Leaks in the rear region, as can occur in split cages, are thereby avoided.

In an embodiment of the present invention, a permanent magnet can, for example, be fastened on the drive shaft, the magnet cooperating with a contactless sensor. Using such sensor/magnet arrangements allows for a highly precise position feedback, wherein the detected position also corresponds to the position of the impeller arranged directly on the drive shaft. No shifts can therefore occur between the position of the impeller and the determined position.

In an embodiment of the present invention, the permanent magnet can, for example, be arranged at the end of the drive shaft far from the displacer housing, whereby, due to their position, the magnet and the contactless sensor, in particular magneto-resistive sensor, are easily accessible and can correspondingly be mounted in a simple manner. A greater influence of the magnetic field of the stator is avoided because of the position of the sensor on the rotational axis of the drive shaft.

In an embodiment of the present invention, the bottom of the can can, for example, be arranged between the permanent magnets arranged on the drive shaft and the contactless sensor, in particular magneto-resistive sensor. The sensor is correspondingly positioned spaced from the magnet and thus protected in the region not flowed through, while it is still easily accessibly so that its electric connection can also be easily made. Errors caused by external magnetic fields are, however, largely excluded by the short existing distance of the sensor from the magnet.

In an embodiment of the present invention, an inlet port and an outlet port can, for example, be formed at the can via which the inner chamber of the can is connected to a flushing line of the device for measuring flow processes. A venting of the inner chamber of the can is therefore possible via these ports so that measuring errors are avoided that are caused by air bubbles released from the inner chamber and entering the conveying chamber.

A particularly simple embodiment for performing these flushing operations is achieved when the inlet port and the outlet port are formed in the region of the collar of the can. This allows the inner chamber of the can to be flushed without having to mount additional lines. The connection to the flushing lines is instead made automatically when mounting the can. The inner chamber of the can may be vented in one step together with the other units of the device.

In an embodiment of the present invention, the inlet port can, for example, be formed in the geodetically lower region of the can, and the outlet port can, for example, be formed in the geodetically upper region of the can. It is thereby prevented that larger volumes of air accumulate in the inner chamber, since the air rises upward and dead spaces otherwise existing there are thus prevented. The air is discharged completely via the upper outlet port.

In a development of the present invention, the flushing line extends from the outlet port of the can through the displacer housing and a piston housing to the outlet. External lines for venting or flushing are omitted. The existing outlet may instead also serve to discharge the air or the flushing fluid.

The flushing line can, for example, extend from a measuring chamber of the differential pressure sensor through the piston housing and the displacer housing to the inlet port of the can. Additional lines can again be omitted. The measuring chamber can instead be vented simultaneously and in a single method step with the can.

A device for measuring flow processes of measuring fluids is thus provided in which the drive unit of the positive displacement flow meter comprises few components and a small structural space, and by which the impeller can be controlled in a highly precise manner. A high-resolution and exact position feedback is also possible so that the measuring values of the device are improved since the position feedback occurs directly at an element coupled with the impeller and elasticities in the drive train are avoided. A reliable venting is provided, whereby measuring results are also improved.

A device for measuring flow processes of fluids according to the present invention will be explained below under reference to a non-restrictive embodiment illustrated in the drawings.

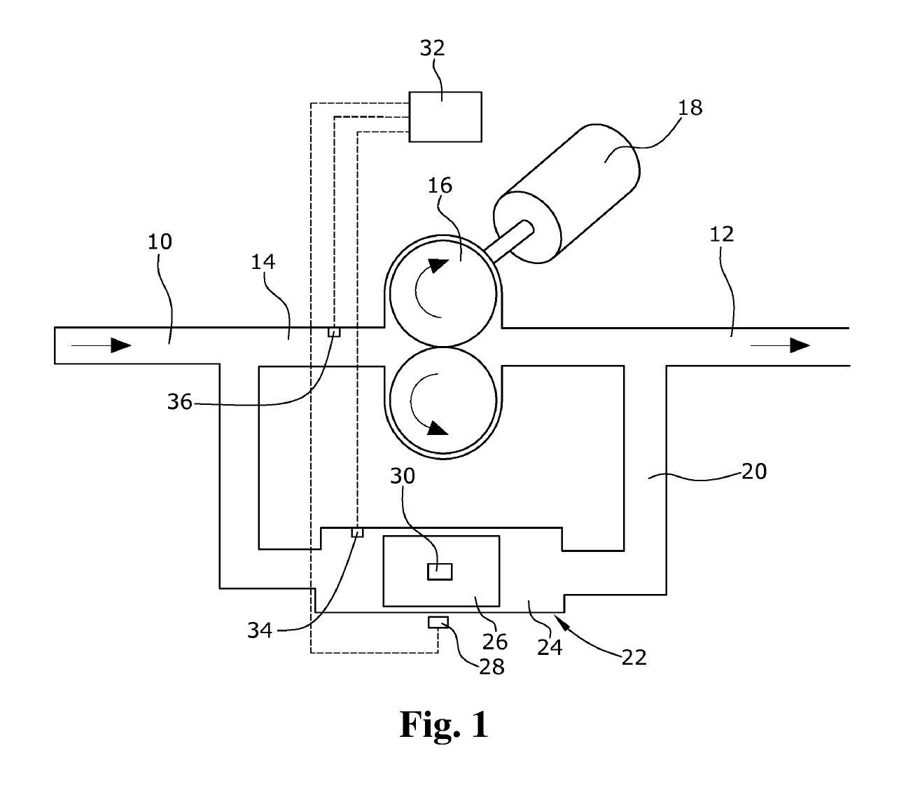

The device for measuring flow processes of fluids illustrated in FIG. 1 comprises an inlet 10 and an outlet 12 which are connected with each other via a main duct 14 in which a rotary positive displacement flow meter 16 is arranged that is designed as a gear pump.

A fluid to be measured, in particular a fuel, flows from a device generating a flow, in particular a high-pressure fuel pump or an injection valve, into the main duct 14 via the inlet 10 and is conveyed via the rotary positive displacement flow meter 16 which can be driven via a drive unit 18.

A bypass 20 branches from the main duct 14 between the inlet 10 and the rotary positive displacement flow meter 16, which bypass 20 opens into the main duct 14 again downstream of the rotary positive displacement flow meter 16 between the positive displacement flow meter 16 and the outlet 12 and which is, as is the main duct 14, fluidically connected to the inlet 10 and the outlet 12. A translational differential pressure sensor 22 is arranged in bypass 20 which is composed of a measuring chamber 24 and a piston 26 free for axial displacement in the measuring chamber 24, the piston 26 having the same specific weight as the measuring fluid, i.e., as the fuel, and having a cylindrical shape like the measuring chamber 24. The measuring chamber 24 thus has an inner diameter that substantially corresponds to the outer diameter of the piston 26.

Due to the fuel being conveyed by the rotary positive displacement flow meter 16, as well as to the injection of the fuel into the inlet 10 and to the fluidic connection of the inlet 10 with the front side of the piston 26, as well as of the outlet 12 with the rear side of the piston 26 via the bypass 20, a pressure difference can be created between the front and the rear side of the piston 26 which causes an excursion of the piston 26 from its rest position 26. The excursion of the piston 26 is accordingly a measure of the prevailing pressure difference.

For a correct determination of this excursion, a magneto-resistive sensor 28 is arranged at the measuring chamber 24, which magneto-resistive sensor 28 is operatively connected to a magnet 30 fastened in the piston 26 and in which the excursion of the piston 26 generates a voltage, via a magnetic field, which is dependent on the magnitude of excursion of the piston 26, the magnetic field varying based on the movement and acting on the magneto-resistive sensor 28.

The magneto-resistive sensor 28 is connected with an evaluation and control unit 32 which receives the values from the magneto-resistive sensor 28 and which transmits corresponding control signals to the drive motor 18 which can, for example, be controlled so that the piston 26 is always in a defined initial position, i.e., so that, by conveying, the rotary positive displacement flow meter 16 continuously approximately balances out the pressure difference generated at the piston 26 because of the fuel injected. The excursion of the piston 26 or the volume displaced by the piston in the measuring chamber 24 is converted therefor into a desired feed volume of the rotary positive displacement flow meter 16 or a rotational speed of the drive motor 18, using a transfer function, and the drive motor 18 is energized accordingly.

A pressure sensor 34 is additionally arranged in the measuring chamber 24, which pressure sensor 34 continuously measures the pressures occurring in this region. A temperature sensor 36 is also located in the main duct 14 for measuring the fluid temperature. Both measuring values are supplied to the evaluation and control unit 32 so that changes in density can be taken into account in the calculation.

The procedure of the measuring is such that, when a total flow rate to be determined is calculated in the evaluation and control unit 32, both a flow rate in the bypass 20 which is generated by the movement or the position of the piston 26 and the volume displaced thereby in the measuring chamber 24, and an actual flow rate of the rotary positive displacement flow meter 16 during a defined time interval are taken into account, and both flow rates are summed to determine the total flow rate.

The determination of the flow rate at the piston 26 is performed, for example, so that, in the evaluation and control unit 32 connected to the magneto-resistive sensor 28, the excursion of the piston 26 is differentiated and subsequently multiplied by the base surface of the piston 26 so that a volume flow in the bypass 20 in this time interval is obtained.

The flow rate through the rotary positive displacement flow meter 16 can be determined either from the control data obtained for controlling the rotary positive displacement flow meter 16 or by the rotational speed, if the rotational speed is measured directly by optical encoders or magneto-resistive sensors.

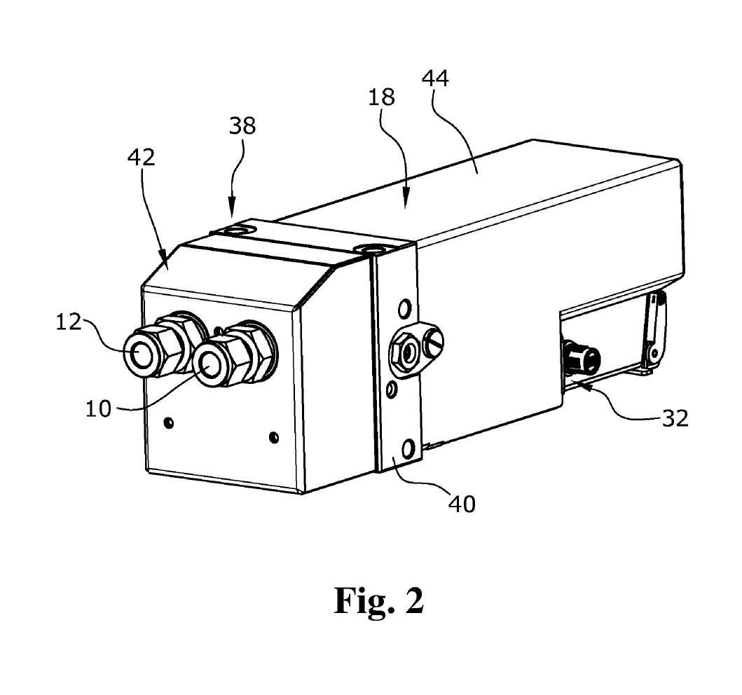

FIG. 2 is a view on the outer side of the device of the present invention for measuring time-resolved flow processes. The device of the present invention comprises a housing 38 of a bipartite structure, wherein a rotary positive displacement flow meter 16 is arranged in the first housing part serving as the displacer housing 40, and the translational differential pressure sensor 22 is arranged in the second housing part serving as the piston housing 42. A drive unit 18 of the positive displacement flow meter 16, as well as the evaluation and control unit 32 are also arranged inside a cover 44 that, like the piston housing 42, is fastened to the displacer housing 40.

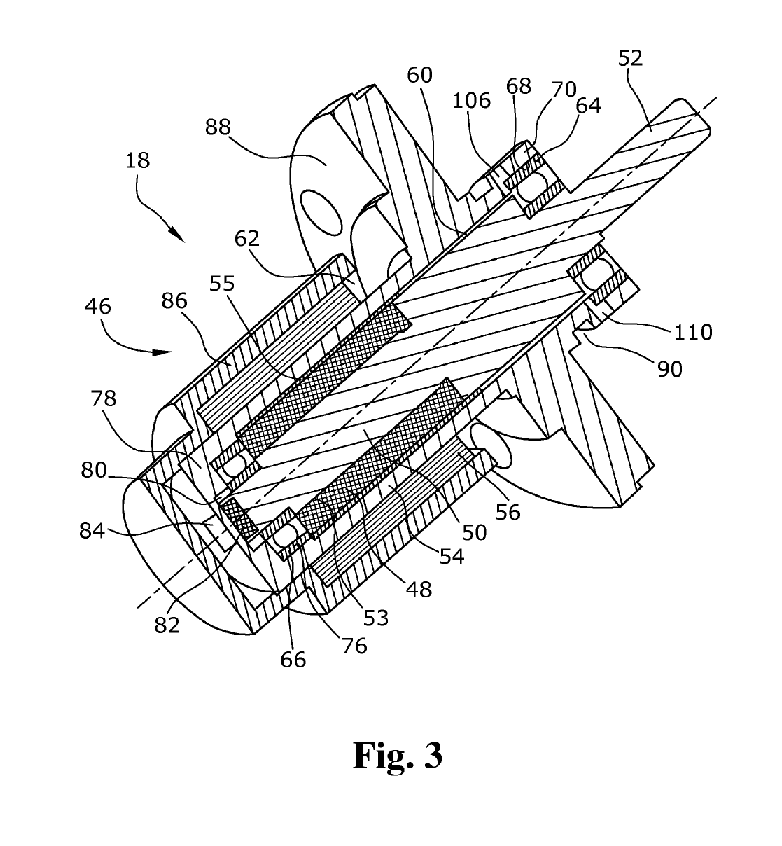

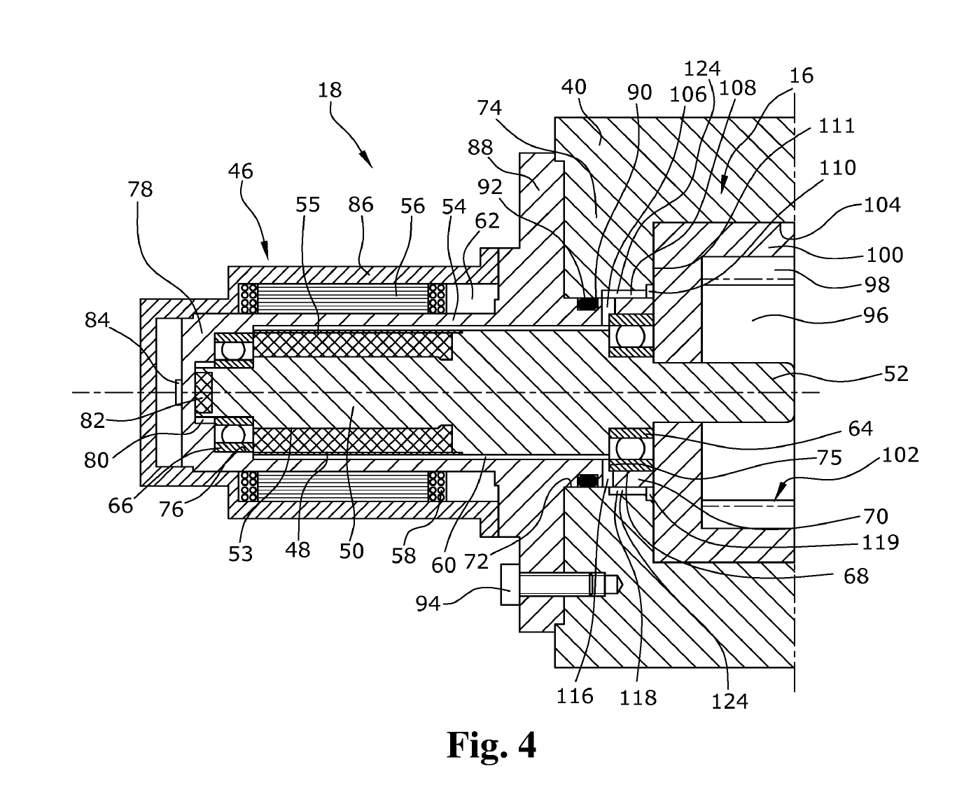

FIG. 3 shows the drive unit 18 for driving the rotary positive displacement flow meter 16. According to the present invention, the drive unit 18 is formed by a canned motor 46. The canned motor 46 has a rotor 50 carrying permanent magnets 48, the rotor 50 being formed by a radial enlarged section of the drive shaft 52 and comprising seats 53 in which the permanent magnets 48 are retained. For the radial fixation of these permanent magnets 48, the rotor 50 is surrounded by a sleeve 55 which closes the seats 53 and which is fastened to the rotor 50. In a manner known per se, this rotor 50 corresponds with a stator 56 arranged radially outside a can 54 and enclosing the rotor 50, the stator 56 comprising windings 58 which are energized in a defined sequence to drive the canned motor 46. The can 54 sealingly separates an inner chamber 60 of the can 54, through which measuring fluid flows and in which the rotor 50 is arranged, from a dry outer chamber 62 in which the stator 56 is arranged. The support of the drive shaft 52 in the can 54 is correspondingly realized by two bearings 64, 66 arranged on axially opposite sides of the rotor 50, which axially abut against the enlarged section by their inner races. A first bearing seat 68 is located in a collar 70 of the can 54, which, as can be seen in FIG. 4, in the mounted state, extends into an opening 72 in a rear wall 74 of the displacer housing 40 and radially abuts on the wall delimiting the opening 72. By its outer race, the first bearing 64 abuts axially against a stop 75 of the collar 70. A second bearing seat 76 is located at the axial end of the can 54 opposite the collar 70, which end is closed in the axial direction by a bottom 78 of the can 54, the second bearing 66 abutting axially against the bottom 78 by its outer race.

In the radially inner region, the bottom 78 has a circular recess 80 into which that end of the drive shaft 52 protrudes at which a circular permanent magnet 82 is formed which is correspondingly arranged immediately opposite the bottom 78 on the rotary axis. On the side of the bottom 78 of the can 54 axially opposite the circular permanent magnet 82, a contactless sensor 84 is arranged which may be designed, for example, as a Hall sensor. This contactless sensor 84 is arranged either directly on the bottom of the can 54 or on a circuit board which may also be arranged at an end of a surrounding motor housing 86 directed towards the bottom 78 of the can 54, which has openings (not shown in the drawings) through which electric lines pass by which the electric connection of the contactless sensor 84 and of the stator 56 fixedly arranged in the motor housing 86 is realized.

The motor housing 86 closes the axial end of the can 54 at which the contactless sensor 84 is arranged, and extends from there in the manner of a hollow cylinder around the stator 56 and the can 54 to a flange 88 of the can 54, which extends radially between the collar 70 and the part of the rotor 50 carrying permanent magnets 48, seen in the axial direction, and the motor housing 86 is fastened to the flange 88.

It can be seen in FIG. 4 that, upon assembly, the can 54 is first pushed with its collar 70 into the opening 72 of the displacer housing until the flange 88 abuts against the rear wall 74 of the displacer housing 40, wherein a radial groove 90 is formed in the radially outer region of the collar 70 into which a sealing 92 is placed that abuts against the wall delimiting the opening 72 so that no measuring fluid can escape to the outside. The can 54 is thereafter fastened on the displacer housing 40 using screws 94 passed through holes in the flange 88. An impeller 96 is fastened on the end of the drive shaft 52 protruding into the displacer housing 40, the impeller 96 being designed as an outer gear and meshing with an inner gear of a ring gear 98 supported in a sleeve 100 closed at the rear side, the sleeve 100 delimiting a conveying chamber 102 of the rotary positive displacement flow meter 16 and being fastened in a receiving opening 104 of the displacer housing 40.

An outlet port 106 is formed between the radial groove 90 and the first bearing seat 68 at the upper side of the collar 70 of the can 54, the outlet port 106 leading radially outward from the inner chamber 60 of the can 54 and opening into a recess 108 in the wall of the displacer housing 40 radially delimiting the opening 72, which is arranged immediately radially opposite. A groove 110 in the rear wall 111 of the displacer housing 40 partially extends around the opening 72 and extends this recess 108 to before an axial bore in the sleeve 100 that opens into a groove of the sleeve 100 which is fluidically connected to a discharge duct of the device which extends through the piston housing 42 to the outlet 12. An inlet port 116 is also formed in the geodetically lower portion of the collar 70 of the can 54 between the radial groove 90 and the first bearing seat 68, the inlet port 116 leading radially inward into the inner chamber 60 of the can 54, the inlet port 116 also being fluidically connected to a recess 118 in the wall of the displacer housing 40 that delimits the opening 72 in the radial direction, which is also arranged immediately opposite the inlet port 116. This recess 118 is fluidically connected to a groove 119 in the rear wall 111 that serves as supply duct, the groove 119 being connected in turn to a bypass port (not shown in the drawings) of the measuring chamber 24 of the translational differential pressure sensor 22 via a passage bore in the sleeve 100 and a continuing duct in the piston housing 42, via which bypass port a connection to the inlet 10 can be made. The grooves 110, 119, the recesses 108, 118, and bores (which are not shown in the drawings) thus serve as a flushing line 124.

Upon start-up, measuring fluid flows into the inlet 10, without the rotary positive displacement meter 16 being driven, and reaches the inner chamber 60 of the can 54 via the measuring chamber 24 of the translational differential pressure sensor 22, the bypass port, the duct in the piston housing 42, the passage bore, the groove 119 and the recess 118 and via the inlet port 116. Since air present in the can 54 rises upward, the air is discharged to the outlet 12 during the flushing via the outlet port 106, the recess 108, the groove 110, the bore, the groove in the sleeve 100 and the discharge duct in the piston housing 42. No air bubbles therefore accumulate in the inner chamber 60 of the can 54, which, due to the compressibility of air, could cause measuring errors, when these air bubbles are released during operation and enter the conveying chamber 102.

The positional feedback for calculating the volume flow conveyed by the rotary positive displacement flow meter 16 is also highly precise, since the impeller 96 is arranged directly on the drive shaft 52 of the drive unit 18 and the position measurement is also effected directly at this drive shaft 52 by the combination if the circular permanent magnet 82 and the contactless sensor 84. The measured position therefore always also corresponds exactly to the position or the number of revolutions of the impeller 96. Elasticities between the positions of the impeller 96 and the measuring point, as they can occur in magnetic clutch rotors, or even a slipping between the magnetic clutch rotors which may lead to erroneous measurements, are avoided. The control according to the signals of the translational differential pressure sensor 22 can also be performed with high precision.

Highly precise measuring results are thus achieved. The required structural space and the number of components are also reduced by using the can 54. A high tightness of the device is nevertheless achieved so that leaking of the measuring fluid is reliably prevented, thereby protecting the stator windings. The device also has a correspondingly long service life.

It should be clear that the present invention is not limited to the embodiment described, but that various modifications are possible. The arrangement of the ducts and of the housing partitions may be changed as well as the design of the positive displacement flow meter which may, for example, also be designed as a double gear pump or a vane pump. The structure of the canned motor can also be changed. Reference should also be had to the appended claims.

What is claimed is:

1-14. (canceled)

15. A device for measuring flow processes of a measuring fluid, the device comprising:
an inlet;
an outlet;
a positive displacement housing;
a drive unit comprising:
a canned motor comprising a drive shaft, a rotor, and a stator comprising windings, and
a can configured to separate an inner chamber, which is filled with the measuring fluid and which holds the drive shaft and the rotor, from an outer chamber, which holds the stator;
a positive displacement flow meter configured to be driven by the drive unit, the positive displacement flow meter being arranged in the positive displacement housing;
a bypass configured to bypass the positive displacement flow meter;
a differential pressure sensor arranged in the bypass; and
an evaluation and control unit configured to provide a control of the positive displacement flow meter based on a pressure difference existing at the differential pressure sensor.

16. The device as recited in claim 15, wherein,
the positive displacement flow meter comprises an impeller, the impeller being fastened on the drive shaft of the canned motor for common rotation therewith, and
the rotor is configured to carry permanent magnets, the permanent magnets being fastened on the drive shaft of the canned motor for common rotation therewith or being manufactured integrally with the drive shaft for common rotation therewith.

17. The device as recited in claim 15, further comprising:
a first bearing seat formed at a first axial end of the can, the first bearing seat comprising a first bearing; and
a second bearing seat formed at a second axial end of the can, the second bearing seat comprising a second bearing,
wherein,
the drive shaft (52) is supported via the first bearing and the second bearing.

18. The device as recited in claim 15, wherein the can comprises a flange via which the canned motor is fastened to the positive displacement housing.

19. The device as recited in claim 18, wherein,
the positive displacement housing comprises an opening,
the first bearing is arranged within the opening of the positive displacement housing, and
the can further comprises a collar, the collar being configured to extend from the flange into the opening of the positive displacement housing.

20. The device as recited in claim 19, wherein the can further comprises a closed bottom, the closed bottom being arranged at an axial end of the can which is remote from the positive displacement housing.

21. The device as recited in claim 20, further comprising:
a contactless sensor); and
a permanent magnet fastened on the drive shaft, the permanent magnet being configured to cooperate with the contactless sensor.

22. The device as recited in claim 21, wherein the permanent magnet is fastened at an end of the drive shaft which is remote from the positive displacement housing.

23. The device as recited in claim 22, wherein the closed bottom of the can is arranged between the permanent magnet fastened on the drive shaft and the contactless sensor.

24. The device as recited in claim 19, further comprising;
a flushing line,
wherein,
the can further comprises an inlet port and an outlet port formed therein, and
the inlet port and the outlet port are arranged to connect the inner chamber of the can to the flushing line.

25. The device as recited in claim 24, wherein the inlet port and the outlet port are formed in a region of the collar.

26. The device as recited in claim 24, wherein,
the inlet port is formed in a geodetically lower portion of the can, and
the outlet port is formed in a geodetically upper portion of the can.

27. The device as recited in claim 24, further comprising:
a piston housing,
wherein,
the flushing line is arranged to extend from the outlet port, through the positive displacement housing and the piston housing, to the outlet of the can.

28. The device as recited in claim 27, wherein,
the differential pressure sensor comprises a measurement chamber, and
the flushing line is arranged to extend from the measuring chamber through the piston housing and the positive displacement housing to the inlet port of the can.
